(19) United States
(12) Patent Application Publication
(10) Pub. No.: US 2008/0105744 A1
(43) Pub. Date: May 8, 2008

(54) Authentication by means of geometric security features

(76) Inventors: Koen Reynaert, Lichtervelde (BE); Johan De Pontieu, Harelbeke (BE)

Correspondence Address: SHLESINGER, ARKWRIGHT & GARVEY LLP, Suite 600, 1420 King Street, Alexandria, VA, 22314, US

(21) Appl. No.: 11/979,126

(22) Filed: Oct. 31, 2007

Related U.S. Application Data
(63) Continuation of application No. PCT/EP2006/061829, filed on Apr. 26, 2006.

(30) Foreign Application Priority Data
Jun. 23, 2005 (EP) 05105577.0
Jun. 23, 2005 (EP) 05105578.8

(51) Int. Cl. G06K 7/08

(52) U.S. Cl. 235/449

(57) ABSTRACT

A method of authenticating value documents has the following steps: a) providing a document to be checked for authenticity, b) providing a high-frequency magnetic excitation field, c) providing a trajectory path for checking the document, d) providing a detection coil, e) the detection coil receiving a detection signal when the document follows the trajectory path, f) deriving geometric parameters from the detection signal, g) comparing the geometric parameters with the geometric parameters of a genuine value document.

### CROSS-REFERENCE TO RELATED APPLICATIONS

This application is a continuation of application no. PCT/EP2006/061829, filed Apr. 26, 2006, which claims the priority of European patent application no. 05105577.0, filed 23 Jun. 2005, and which application no. PCT/EP2006/061829, filed Apr. 26, 2006, claims the priority of European patent application no. 05105578.8, filed 23 Jun. 2005, and each of which is incorporated herein by reference.

### FIELD OF THE INVENTION

The present invention relates to a method for authenticating value documents. The value documents, if genuine, comprise magnetic security particles spread in or on a predetermined or pre-selected location of the value documents.

### BACKGROUND OF THE INVENTION

Integrating magnetic security particles in value documents is known. U.S. Pat. No. 5,992,741 discloses integrating soft-magnetic or semi-soft-magnetic fibers of a particular geometry in value documents such as bank notes or credit cards.

U.S. Pat. No. 5,992,741 also discloses a way of detecting the presence of the magnetic fibers in value documents. The disclosed detection method is based upon an analysis of the harmonics present in the detection signal.

U.S. Pat. No. 6,707,295 discloses another way of authenticating value documents. This disclosed detection method is based upon an analysis of the dB/dt response signal, which allows deriving magnetic parameters such as the magnetic coercivity or the magnetic saturation.

As counterfeiting becomes more imminent, protection of value documents has become more sophisticated, e.g. by combination of various different security characteristics.

WO-A-2005/105902 of applicant mentions the possibility of concentrating the security particles only on predetermined or pre-selected locations of a genuine value document.

U.S. Pat. No. 5,545,885 discloses a method and apparatus to detect and identify coded patterns on bank notes in the form of magnetic regions. These magnetic regions are small areas printed with ink containing a magnetic pigment.

U.S. Pat. No. 4,864,238 discloses a device for measuring a weak magnetic field. This device can be used for measuring fields associated with bank notes for identifying the denomination or values of bank notes.

U.S. Pat. No. 5,808,466 discloses a process for the characterization of magnetic materials for validating documents. The process uses a low-frequency signal emitter. The form of the detection signal is analyzed as to the particular position of the magnetic materials in the documents.

### OBJECTS AND SUMMARY OF THE INVENTION

The present invention provides for a method of checking both the genuineness of the security particles and the correct location of the security particles in the value document.

According to the present invention, there is provided a method of authenticating value documents. The value documents, if genuine, comprise magnetic security particles spread in or on a predetermined location of the value documents.

The method comprises the following steps:
a) providing a document to be checked for authenticity;
b) providing a high-frequency magnetic excitation field;
c) providing a trajectory path for checking the document;
d) providing a detection coil;
e) the detection coil receiving a detection signal when the document follows the trajectory path;
f) deriving geometric parameters from the detection signal;
g) comparing the geometric parameters with the geometric parameters of a genuine value document.

A conclusion to genuineness can be made in case the geometric comparison g) is positive.

Within the context of the present invention, the terms ‘value documents’ generally refer to bank notes, credit cards, passports, bonds, etc.

The term ‘magnetic’ refers to magnetic material exhibiting a non-linear BH-curve when being subjected to an alternating excitation field H. Magnetic material preferably refers to soft-magnetic material with magnetic coercivities below 100 A/m (measured at near-DC or low frequencies) and to semi-soft magnetic material with magnetic coercivities higher than 100 A/m (measured at near-DC or low frequencies).

The term ‘particles’ refers to small elements being able to be integrated in or on the substrate of value documents. The term ‘particles’ also refers to fibers having a diameter ranging from 1 μm to 30 μm and having a length ranging from 1 mm to 20 mm.

The term ‘high-frequency’ refers to frequencies higher than 1000 Hz, e.g. higher than 3000 Hz. The higher the frequency, the higher the speed of detection.

In a particular embodiment of the invention one or more detection coils can be provided with a varying concentration of windings along the trajectory path of the document.

The terms ‘detection coil with a varying concentration of windings along the trajectory path’ refer to a detection coil or a combination of various detection coils where the number of windings per unit of length along the trajectory path varies.

A simple embodiment of a detection coil with a varying concentration of windings is a detection coil with windings along a part of the trajectory path and without windings along another part of the trajectory path. Another embodiment is realized where the distance between subsequent windings varies, e.g. by varying the thickness of insulation between the windings.

As to step f), various geometric or physical parameters may be derived from the detection signal.

As a first possibility, the maximum amplitude of the detection signal may be determined and is a measure for the width of the region where magnetic particles are present.

As a second possibility, the abscissa of the maximum amplitude in the detection signal may be determined after having detected the edge of the value document. As will be explained hereafter, this abscissa is a measure for the global or average position or location of the location of the magnetic security particles in the document.

A third possibility is to analyze the form of the detection signal. As will be explained hereafter, the presence or not of sub-maxima and sub-minima and the respective amplitudes or differences in amplitude may be an indication of the width of the location of the magnetic security particles.

In addition to the derivation of various geometric parameters, various magnetic parameters may be derived from the detection signal.

A preferable method is to determine the maximum amplitude of the detection signal. This amplitude is a measure for the concentration of the magnetic particles in the value document. The higher the concentration the higher the amplitude. The genuineness of the value document may be based not on the mere presence of the security particles but on the presence of the security particles within a selected range of concentration. Alternatively, or in addition, the excitation current corresponding to the maximum amplitude may be determined. This excitation current is a measure for the magnetic coercivity of the magnetic particles and may be an indication of the genuineness of the value document.

In the embodiment where both geometric features and magnetic features are derived from the detection signal, a preferable embodiment allows to make a positive conclusion as to genuineness of the document only in case both the magnetic comparison with a genuine document and the geometric comparison with a genuine document are positive. If the magnetic comparison is negative, or if the geometric comparison is negative or if both are negative, a conclusion as to counterfeit may be made.

The method according to the invention can be used in a bank note sorting machine, a bank note counting machine, an apparatus for distributing bank notes, automatic vending machines, apparatus for authenticating credit cards, etc.

### BRIEF DESCRIPTION OF THE DRAWINGS

FIG. 1 shows a BH curve of a magnetic material;

FIG. 2 shows both a sinusoidal applied magnetic field and a measured magnetic response from a magnetic material;

FIG. 3 shows a detection apparatus suitable for carrying the detection method according to the invention;

FIG. 4, FIG. 5, FIG. 6, FIG. 7, FIG. 8, FIG. 9 and FIG. 10 all show the subsequent response signals captured when a value document is going through a detection apparatus;

FIG. 11 shows the global response signal;

FIG. 12 shows various global response signals and the parameters derived from it;

FIG. 13 shows an alternative embodiment of a detection apparatus;

FIG. 14 shows another embodiment of a detection apparatus.

### DETAILED DESCRIPTION OF THE INVENTION

FIG. 1 shows a so-called BH-curve 10 of a magnetic material in the context of the present invention, i.e. a magnetic material with a non-linear hysteresis behavior. The abscissa is the magnetic field H expressed in amperes/meter (A/m) and the ordinate is the magnetic induction B expressed in Tesla (T) or Oersted (Oe). Characteristic magnetic parameters are the coercive field H_{c}, which is the field at which the magnetic response becomes zero, and the saturation value Bs, which is the magnetic induction at the onset of saturation.

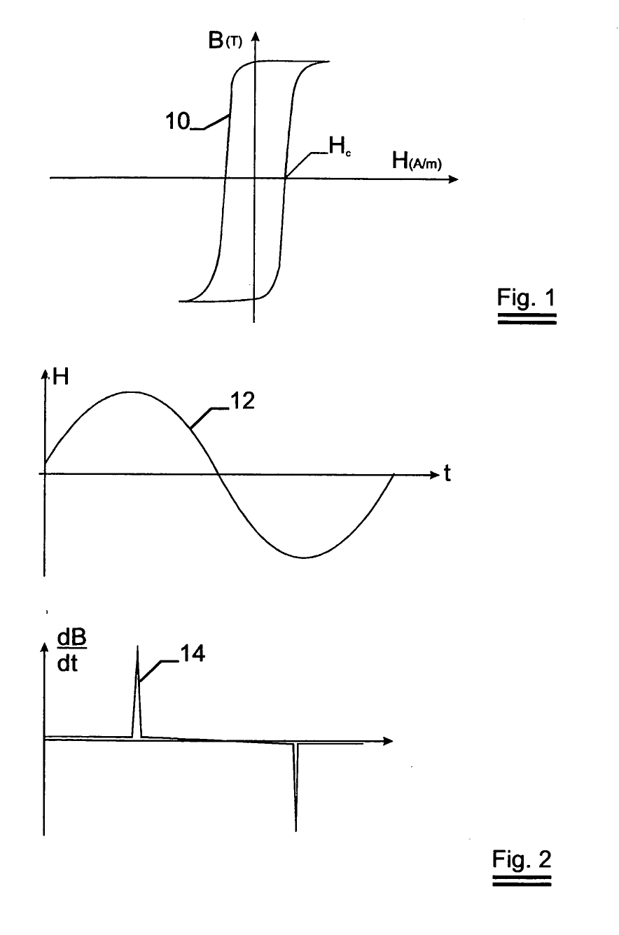

Reference is now made to FIG. 2. A sinusoidal magnetic field 12 is applied to the magnetic material particles inside a value document. The measured magnetic response dB/dt (the time derivative of the magnetic induction B) gives two peaks 14.

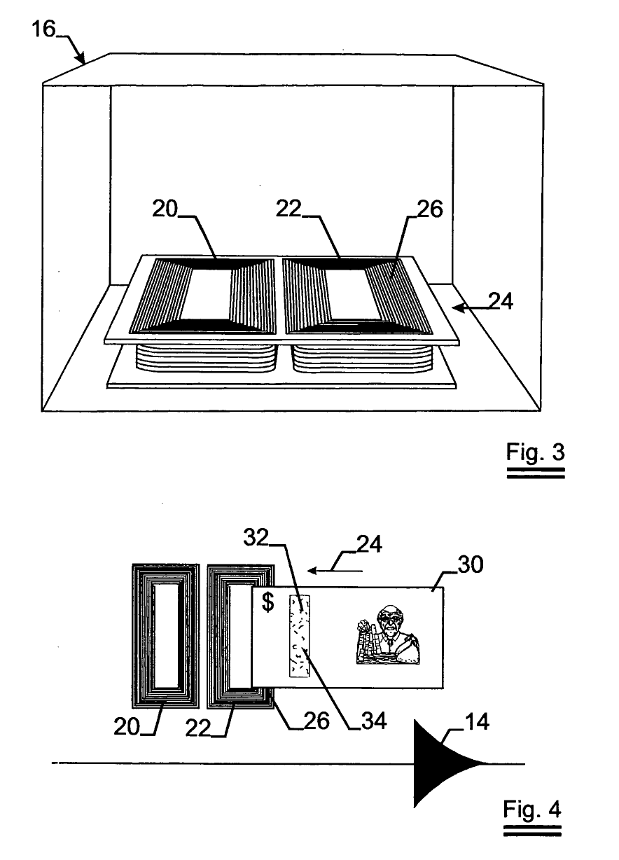

FIG. 3 schematically shows a detection apparatus 16 which is suitable for carrying out a detection method according to the present invention. For the purpose of clarity, only the detection coils 20 and 22 are represented. A document to be checked for authenticity will be guided along a trajectory path in the direction of arrow 24. Along this trajectory path the concentration of windings 26 is not constant but is—deliberately—changing. Roughly outlined, following regions may be distinguished along the trajectory path:
i) in the beginning, absence of windings;
ii) the right windings 26 of the right detection coil 22;
iii) absence of windings in the middle of detection coil 22;
iv) the left windings 26 of the right detection coil 22;
v) the right windings 26 of the left detection coil 20;
vi) absence of windings in the middle of detection coil 20; and
vii) the left windings 26 of the left detection coil 20.

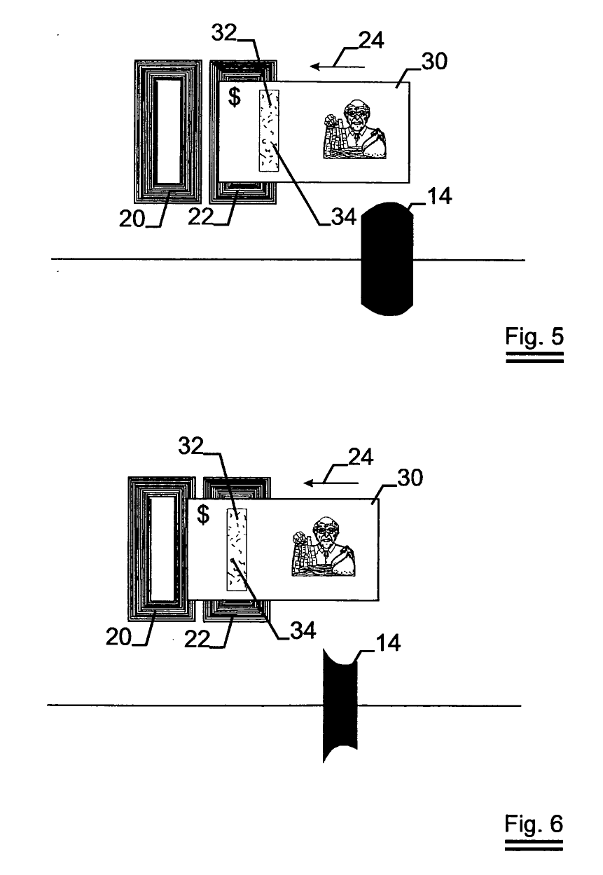

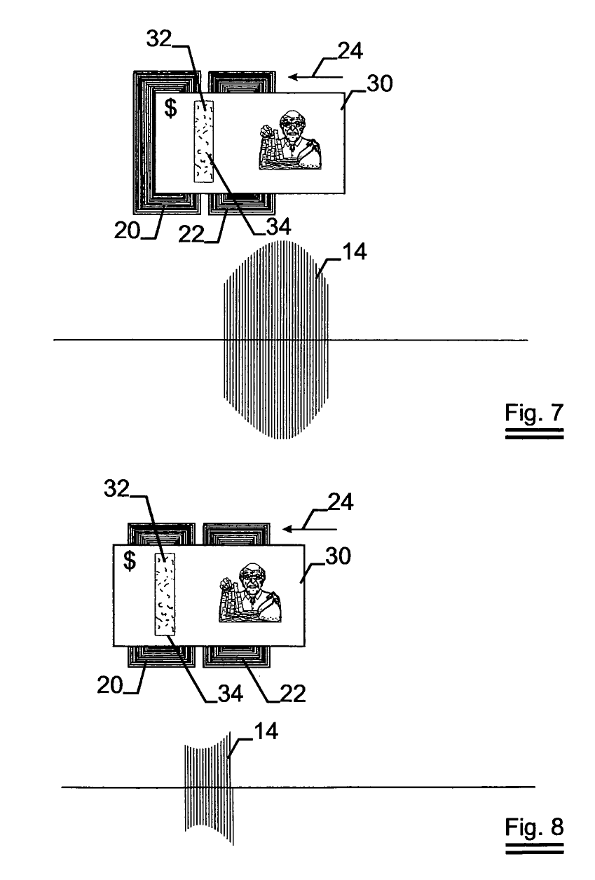

FIG. 4, FIG. 5, FIG. 6, FIG. 7, FIG. 8, FIG. 9, and FIG. 10 all illustrate the subsequent stages of a value document 30 passing along the trajectory 24.

Document 30 if genuine comprises a predetermined and pre-selected region 32 which does not extend to the whole volume of value document 30 and where magnetic security particles 34 are spread. The document 30 follows the trajectory path 24 from right to left. A high-frequency magnetic field is applied.

FIG. 4 illustrates the start of document 30 passing along the trajectory 24. In the very start, there is no detection of dB/dt signals 14 since the presence of security particles 34 cannot yet be noticed by the right detection coil 22. Document 30 approaching the right windings 26 of right detection coil 22, a dB/dt signal 14 starts to be detected and an increasing amplitude is noticed since the document 30 is coming closer and since the population of windings 26 becomes denser.

FIG. 5 illustrates the second stage. The predetermined region 32 of security particles 34 is passing in close neighborhood to the right windings 26 of right detection spool 22. The amplitude 14 of the dB/dt detection signal is exhibiting a maximum.

FIG. 6 illustrates the third stage. The predetermined region 32 of security particles 34 is passing in close neighborhood to the center part of the right detection spool 22 where there are no windings. The amplitude 14 of the dB/dt detection signal is exhibiting a minimum.

FIG. 7 illustrates the fourth stage. The predetermined region 32 of security particles 34 is passing in close neighborhood to the left windings of right detection coil 22 closely followed by the right windings of left detection coil 20. Both windings represent a very dense and close population of windings. The amplitude 14 of the dB/dt detection signal is exhibiting an absolute maximum.

FIG. 8 illustrates the fifth stage. The predetermined region 32 of security particles 34 is passing in close neighborhood to the center part of the left detection spool 20 where there are no windings. The amplitude 14 of the dB/dt detection signal is exhibiting a minimum.

FIG. 9 illustrates the sixth stage. The predetermined region 32 of security particles 34 is passing in close neighborhood to the left windings of the right detection spool 20. The amplitude 14 of the dB/dt detection signal is exhibiting a local maximum.

FIG. 10 illustrates the seventh stage. The predetermined region 32 of security particles is leaving the neighborhood of the left windings of the right detection spool 20. The amplitude 14 of the dB/dt detection signal is decreasing until zero.

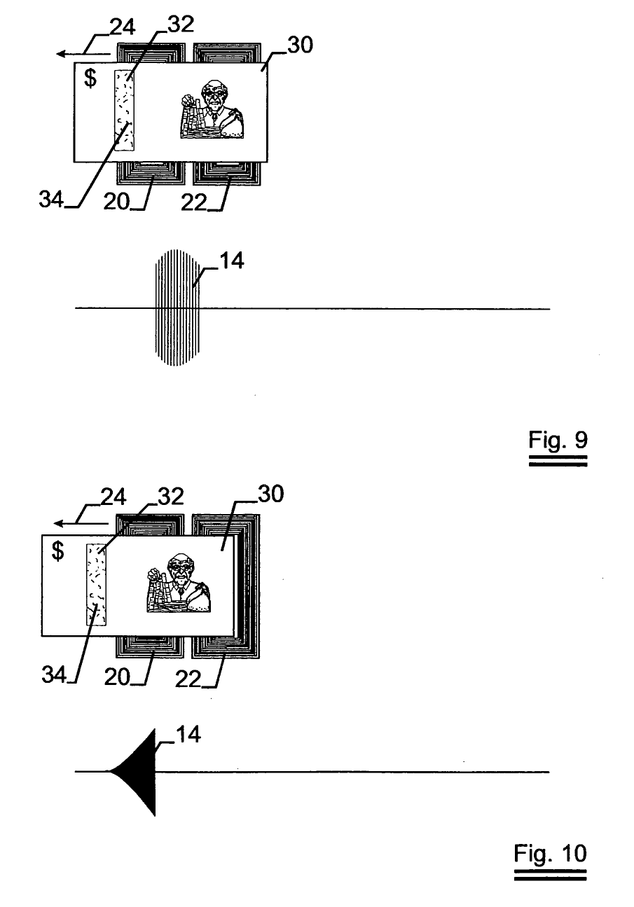

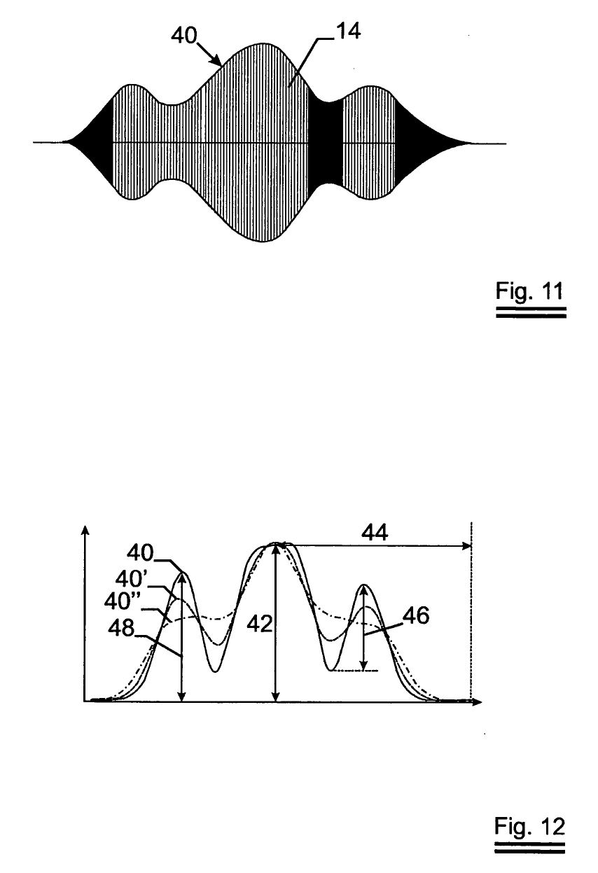

FIG. 11 illustrates the global result of all the various subsequent stages. Curve 40 is a curve enveloping all measured dB/dt amplitudes 14. Curve 40 will be used to derive both magnetic and geometric parameters from the document to be authenticated.

FIG. 12 shows various types of enveloping curves 40, 40′ and 40″ and illustrates various values which can be derived from these curves.

Curve 40 corresponds to a document with a relatively narrow predetermined region 32 of security particles 34. As this predetermined region is quite narrow, the absence or presence of detection coils is felt more sharply when this document passes the trajectory 24.

Curve 40″ corresponds to a document with a relatively large predetermined region 32 of security particles 34. As this predetermined region is quite large, the absence or presence of detection coils is more spread and curve 40″ is more smooth than curve 40.

Curve 40′ corresponds to a document with an predetermined region 32 of security particles 34 that is larger than the region 32 of the document producing curve 40 and more narrow than the region 32 of the document producing curve 40″. Curve 40′ holds somewhat the middle between curve 40 and curve 40″. Any way, the various curves 40, 40′ and 40″ show that a detection signal 40, which is by essence a magnetic detection signal, gives indications about the geometrical width of the predetermined region 32 of security particles 34.

Following parameters may be derived from the enveloping curve 40:
the maximum amplitude 42 of curve 40 over the whole trajectory 24; this amplitude is an indication of the concentration of security particles 34; the higher the concentration the higher the amplitude 42;
the abscissa value 44 of the maximum amplitude, this abscissa 44 is an indication of the (average) position of the predetermined region 32 within a value document 30
the lobe-valley difference 46 (or difference between a local maximum and a local minimum); as explained here above with respect to curves 40, 40′ and 40″, this lobe-valley difference 46 is an indication of the width of the predetermined region 32 with the security particles 34. The enveloping curve 40 shows two lobe-value differences 46. Either one of the values can be taken, or, preferably, the average value of the two values can be taken as this is a more robust parameter
the lobe value 48 (or local maximum 48) may be—just as the lobe-valley value 46—an indication of the width of the predetermined region 32. The absolute value 48 of the lobe is also dependent upon the magnetic parameters.

Next to these four parameters, other parameters may also be derived. One example is the excitation current which corresponds to the maximum response amplitude 40. This excitation current is an indication for the coercive field H_{c}.

The complete course of the enveloping curve 40 may be also be checked and compared with minima and maxima between which a response of a genuine document must fit.

The detection apparatus 16 is calibrated by passing various genuine documents 30 through it and by determining the maximum values and minimum values for the various magnetic and geometric parameters.

After this calibration process, the apparatus 16 is ready for authentication. A document passing through it, is considered genuine only if it meets both magnetic and geometric limit ranges.

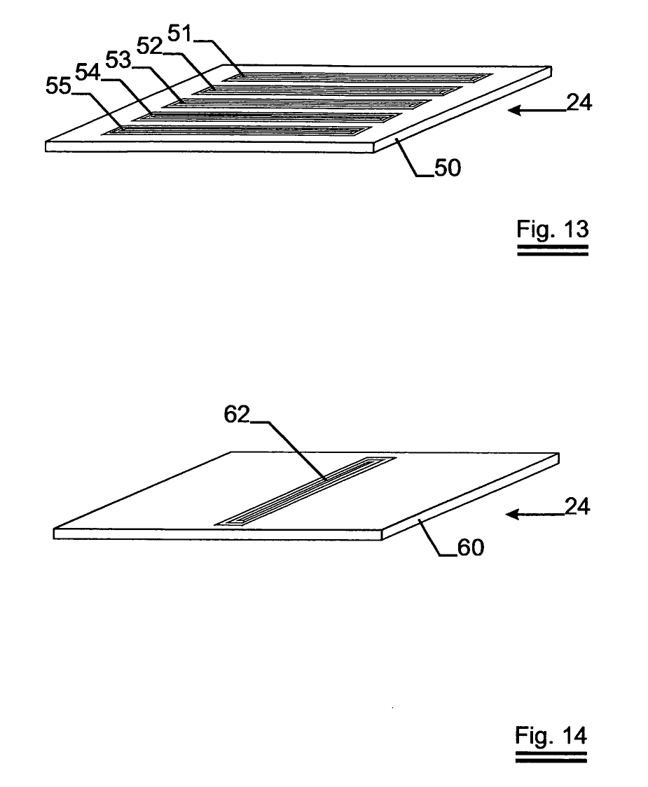

In addition to detection apparatus 16 or as alternative for detection apparatus 16, the alternative embodiment of FIG. 13 may be used. The alternative embodiment is a printed circuit board (PCB) 50 or a layer of a PCB in addition to other layers. This PCB lodges, for example, five elongated and relatively thin detection coils 51, 52, 53, 54 and 55. The five detection coils 51, 52, 53, 54 and 55 lie parallel to the trajectory path 24. Each of the detection coils 51, 52, 53, 54 and 55 gives a response signal in case security particles are detected in the neighborhood of each coil. So this embodiment has the advantage of giving an estimate not of the width of the predetermined zone 32 but of the height of the predetermined zone 32. The higher the number of thin spools the higher the accuracy is of the height of the predetermined zone 32.

Yet another embodiment of a detection apparatus is illustrated in FIG. 14. Again, this embodiment may be used as alternative or in addition to the detection apparatus 16. This other embodiment is a printed circuit board (PCB) 60 or a layer of a PCB. This PCB lodges a very thin detection coil 62 in a direction perpendicular to the trajectory path 24 of the value documents 30. The thin character of detection coil 62, which means a small width in the direction of the trajectory path 24, has the advantage of providing a very sharp signal in case security particles 34 are present in the document to be checked. This sharpness of the signal helps to determine the width of the predetermined zone in a better way.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A method of authenticating value documents, said value documents if genuine comprise magnetic security particles spread in or on a predetermined location of said value documents, said method comprising the following steps:
a) providing a document to be checked for authenticity;
b) providing a high-frequency magnetic excitation field;
c) providing a trajectory path for checking the document;
d) providing a detection coil,
e) said detection coil receiving a detection signal when said document follows said trajectory path;
f) deriving geometric parameters from said detection signal;
g) comparing said geometric parameters with the geometric parameters of said predetermined location of a genuine value document.

2. A method as claimed in claim 1, said method comprising as additional step:
a) concluding to genuineness in case the geometric comparison of said step of comparing said geometric parameters with the geometric parameters of said predetermined location of a genuine value document is positive.

3. A method as claimed in claim 1, wherein said detection coil has a varying concentration of windings along the trajectory path of the document.

4. A method as claimed in claim 1, wherein the maximum amplitude is recorded as a measure for the width of the region where the magnetic particles are present.

5. A method as claimed in claim 1, wherein the edge of the value document is detected and wherein the abscissa position of the maximum amplitude is recorded as a measure for the position of a location where the magnetic particles are present.

6. A method as claimed in claim 1, wherein an additional detection coil is used and wherein said detection signal is scanned as to the presence of sub-maxima and sub-minima, and wherein the difference between the amplitude of the sub-maxima and the sub-minima is a measure for the width of a location where magnetic particles are present.

7. A method as claimed in claim 1, wherein said detection coil has a width which is smaller than the dimension of said predetermined location along the trajectory path and wherein the active part of said detection coil is oriented perpendicular to said trajectory path.

8. A method as claimed in claim 1, wherein said detection coil has a width which is smaller than the dimension of said predetermined location in a direction perpendicular to the trajectory path and wherein the active part of said detection coil is oriented parallel to said trajectory path.

9. A method as claimed in claim 8, wherein there is more than one such detection coil.

10. A method as claimed in claim 1, wherein magnetic parameters are derived from said detection signal.

11. A method according to claim 10, wherein said magnetic parameters are compared with the magnetic parameters of a genuine value document.

12. A method according to claim 11, wherein a conclusion to genuineness is only made in case both the magnetic comparison and the geometric comparison is positive.

13. A method according to claim 10, wherein the maximum amplitude of the detection signal is recorded as a measure for the concentration of the magnetic security particles.

14. A method as claimed in claim 10, wherein the excitation current at said maximum amplitude is recorded as a measure for the magnetic coercivity.

15. Use of a method as claimed in claim 14 in a bank note sorting machine.

16. Use of a method as claimed in claim 1 in a bank note sorting machine.
